(19) United States
(12) Patent Application Publication
(10) Pub. No.: US 2026/0269634 A1
(43) Pub. Date: Sep. 10, 2026

(54) PARALLEL BATTERY CLUSTER TOPOLOGY INTEGRATED WITH CIRCULATING CURRENT SUPPRESSION AND STATE-OF-CHARGE EQUALIZATION CIRCUIT

(71) Applicant: Guangzhou Pwr Sp Bur of Guangdong Pwr Grd Co. Ltd., Guangzhou (CN)

(72) Inventors: Zhiyuan MA, Guangzhou (CN); Zhipeng SU, Guangzhou (CN); Hongbin WANG, Guangzhou (CN); Zhong XU, Guangzhou (CN); Le LUAN, Guangzhou (CN); Kai ZHOU, Guangzhou (CN); Shuo XU, Guangzhou (CN); Yu QIN, Guangzhou (CN)

(73) Assignee: Guangzhou Pwr Sp Bur of Guangdong Pwr Grd Co. Ltd., Guangzhou (CN)

(21) Appl. No.: 18/849,614

(22) PCT Filed: Mar. 23, 2023
(86) PCT No.: PCT/CN2023/083478

§ 371 Date: Sep. 23, 2024

(30) Foreign Application Priority Data
Mar. 24, 2022 (CN) 202210294443.0

(51) Int. Cl. H02J 7/56; H02J 7/00; H02J 7/60; H02J 7/82; H02J 7/90; H02J 7/94

(52) U.S. Cl. CPC H02J 7/56; H02J 7/663; H02J 7/82; H02J 7/855; H02J 7/933; H02J 7/94; H02J 2207/20

(57) ABSTRACT

The present disclosure relates to a parallel battery cluster topology integrated with a circulating current suppression and state-of-charge equalization circuit. The circulating current suppression and state-of-charge equalization circuit includes a plurality of voltage sources and parallel battery clusters, voltage sources being connected in series with parallel battery clusters. Positive electrodes of a first voltage source to an n-th voltage source are respectively connected to negative electrodes of a first battery cluster to an n-th battery cluster, and negative electrodes of the first voltage source to the n-th voltage source are connected together to form a negative electrode of the parallel battery clusters.

### CROSS-REFERENCE TO RELATED APPLICATIONS

This application is a national stage for International Application PCT/CN2023/083478, filed on Mar. 23, 2023, and entitled “PARALLEL BATTERY CLUSTER TOPOLOGY INTEGRATED WITH CIRCULATING CURRENT SUPPRESSION AND STATE-OF-CHARGE EQUALIZATION CIRCUIT”, which claims the priority benefit of Chinese Patent Application No. 202210294443.0 filed on Mar. 24, 2022. The entireties of both applications are incorporated by reference herein for all purposes.

### TECHNICAL FIELD

The present disclosure relates to the field of automobile power battery technologies, and in particular, to a parallel battery cluster topology integrated with a circulating current suppression and state-of-charge equalization circuit.

### BACKGROUND

Due to the inconsistency of batteries in manufacturing, working environment, and aging degree, the state of charge of each battery is inconsistent during the charging and discharging cycle of the energy storage system. For battery clusters connected in parallel, during the charging process, there will be a situation where one battery cluster is fully charged while the other battery clusters are not. In order to avoid overcharging the battery cluster, the remaining battery clusters will not be able to continue charging to full capacity. Similarly, during the discharge process, there may be a situation where one battery cluster has reached its minimum allowable state of charge, while the rest of the battery clusters can still continue to be discharged. Therefore, to avoid damage caused by over-discharge of the battery cluster, all battery cells connected in parallel and in series will stop further discharging. It can be seen that the inconsistency of the battery performance will limit the available capacity of the battery clusters in parallel, resulting in the waste of the configured capacity and increasing the cost of the energy storage system.

Chinese patent application CN111916855A provides a battery parallel equalization circuit and a control circuit, including N battery modules in parallel and an equalization device in series. The equalization device includes two switches and a current-limiting resistor. The equalization device equalizes batteries of different voltages through a series-parallel structure of the current-limiting resistor and switches, and has a simple structure.

Chinese patent application CN106712168A provides a parallel battery cluster bi-directional lossless equalization circuit based on inductive energy storage. The circuit includes a battery strobe network composed of a plurality of sets of bi-directional switches and an inductor for storing energy. Through the equalization circuit and energy storage inductor between the two parallel battery clusters, the energy of one battery cluster can be transferred to the other battery cluster, and can also be obtained from the other battery cluster. Therefore, the equalization circuit can equalize the dynamic equalization of the battery clusters.

### SUMMARY

The present disclosure provides a parallel battery cluster topology integrated with a circulating current suppression and state-of-charge equalization circuit. The circulating current suppression and state-of-charge equalization circuit includes a plurality of parallel battery clusters, and a plurality of voltage sources connected in series with the parallel battery clusters.

A positive electrode of a first voltage source U₁, a positive electrode of a second voltage source U₂, . . . , and a positive electrode of an n-th voltage source Uₙ are respectively connected to a negative electrode of a first battery cluster B₁, a negative electrode of a second battery cluster B₂, . . . , and a negative electrode of an n-th battery cluster Bₙ. Negative electrodes of the first voltage source U₁ to the n-th voltage source Uₙ are connected together to form a negative electrode of the parallel battery clusters.

During operation, by controlling the polarity and amplitude of the voltage source, an output current of the corresponding battery cluster is controlled, thereby controlling the energy flow among different parallel battery clusters.

Further, the circulating current suppression and state-of-charge equalization circuit is specifically a converter topology with an output capacitor, including battery clusters, series capacitors, bi-directional converters, an intermediate bus capacitor, and a bi-directional DC/DC converter.

Positive electrodes of the battery clusters are connected to one another as a positive electrode of the parallel battery cluster. Negative electrodes of battery clusters are connected in series with the series capacitors. The negative electrodes of the series capacitors are connected to one another as a negative electrode of the parallel battery cluster. The series capacitors are connected to the intermediate bus capacitor via a bi-directional converter for bi-directional energy transfer.

Further, each of the positive electrodes of the battery clusters is connected to one another as the positive electrode of the parallel battery cluster. Specifically, the positive electrode of the first battery cluster B₁, the positive electrode of the second battery cluster B₂, . . . , and the positive electrode of the n-th battery cluster Bₙ are connected to one another as the positive electrode of the parallel battery cluster. The series capacitors include a first series capacitor C₁, a second series capacitor C₂, . . . , and an n-th series capacitor Cₙ. The negative electrode of the first battery cluster B₁, the negative electrode of the second battery cluster B₂, . . . , and the negative electrode of the n-th battery cluster Bₙ are connected to a positive terminal of the first series capacitor C₁, a positive terminal of the second series capacitor C₂, . . . , and a positive terminal of the n-th series capacitor Cₙ, respectively. The negative terminal of the first series capacitor C₁, the negative terminal of the second series capacitor C₂, . . . , and the negative terminal of the n-th series capacitor Cₙ are connected to one another as the negative electrode of the parallel battery cluster.

Further, the series capacitors are connected to the intermediate bus capacitor via the bi-directional converter. Specifically, the first series capacitor C₁, the second series capacitor C₂, . . . , and the n-th series capacitor Cₙ are connected to the intermediate bus capacitor C₀ via a first bi-directional converter, a second bi-directional converter, . . . , and an n-th bi-directional converter, respectively.

Further, the voltage source includes a bi-directional converter and a DC/DC converter with an output series capacitor and a load short-circuit switch, the bi-directional converter being cascaded to a DC/DC converter which is connected to an output capacitor for the parallel battery cluster.

Further, the parallel battery cluster topology integrated with the circulating current suppression and state-of-charge equalization circuit includes a control circuit. The control circuit includes a battery cluster state of charge monitoring circuit and a bi-directional converter control circuit. The battery cluster state of charge monitoring circuit is connected to the control circuit such that the state of charge of all battery clusters may be detected by the control circuit. The gates of switch transistors of the bi-directional converter and the bi-directional DC/DC converter are connected to the control circuit, such that the turn-on and turn-off of all switch transistors may be controlled by the control circuit.

Further, the bi-directional converter is specifically a compound chopper circuit with a load short-circuit switch.

The intermediate bus capacitor C₀ is connected to a high-voltage end of the compound chopper circuit, and the series capacitor is connected to a low-voltage end of the compound chopper circuit. The positive terminals of a first series capacitor C₁, a second series capacitor C₂, . . . , and an n-th series capacitor Cₙ are connected to the drains of the load short-circuit switches M₁, M₂, . . . , and Mₙ respectively. The negative terminals of the first series capacitor C₁, the second series capacitor C₂, . . . , and the n-th series capacitor Cₙ are connected to the sources of the load short-circuit switches M₁, M₂, . . . , and Mₙ respectively, and are jointly connected to the negative electrode of the parallel battery clusters.

Further, the bi-directional DC/DC converter is specifically a bi-directional DC converter with output voltage stabilization function, and is configured to maintain the stability of the bus capacitor voltage. The intermediate bus capacitor C₀ is connected to the output terminal of the bi-directional DC converter, and the output capacitor for the parallel battery cluster is connected to the input terminal of the bi-directional DC/DC converter.

Further, by controlling the switching of the switch transistors in each bi-directional converter during operation, power of part of the parallel battery clusters are transferred to the remaining parallel battery clusters through a common output bus of the parallel battery clusters, thereby realizing the circulating current suppression among the battery clusters and the controlling of the state-of-charge equalization among the battery clusters.

Further, during operation, the following equation is satisfied:

$${\sum }_{i = 1}^{n} {U}_{ci} \cdot {I}_{i} = 0$$

The total power consumption of the series capacitor in the process of the circulating current suppression and state-of-charge equalization is 0. Meanwhile, a voltage fluctuation amplitude of the intermediate bus capacitor is 0 by voltage stabilization of the DC/DC converter.

### BRIEF DESCRIPTION OF THE DRAWINGS

FIG. 1 is a structural diagram of a parallel battery cluster topology integrated with a circulating current suppression and state-of-charge equalization circuit of the present disclosure.

FIG. 2 is a topological structure in an embodiment of the present disclosure.

FIG. 3 is a waveform diagram of a drive signal for a positive polarity series capacitor voltage output and related signals in an embodiment of the present disclosure.

FIG. 4 is a waveform diagram of a drive signal for a negative polarity series capacitor voltage output and related signals in an embodiment of the present disclosure.

FIG. 5a shows an operating mode in which the main switches S₁₁, S₁₄, S₂₂, and S₂₃ are in an on state during the control process of the bi-directional converter in an embodiment of the present disclosure.

FIG. 5b shows an operating mode in which the main switches S₁₂, S₁₃, S₂₁, and S₂₄ are in an on state during the control process of the bi-directional converter in an embodiment of the present disclosure.

FIG. 5c shows an operating mode in which the main switches S₁, S₁₄, S₂₂, and S₂₄ are in an on state during the control process of the bi-directional converter in an embodiment of the present disclosure.

FIG. 5d shows an operating mode in which the main switches S₁₂, S₁₄, S₂₂, and S₂₃ are in an on state during the control process of the bi-directional converter in an embodiment of the present disclosure.

### DETAILED DESCRIPTION OF THE EMBODIMENTS

The present disclosure will be described in further detail below in conjunction with the embodiments and drawings, but the implementation of the present disclosure is not limited thereto.

### EMBODIMENT

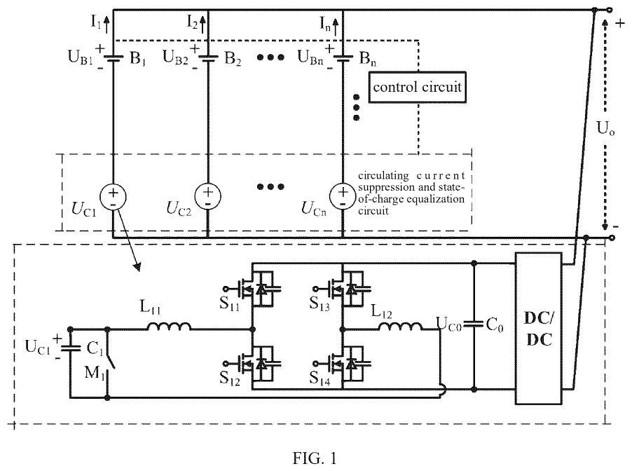

Referring to FIG. 1, the present disclosure provides a parallel battery cluster topology integrated with a circulating current suppression and state-of-charge equalization circuit, which includes a plurality of parallel battery clusters and voltage sources connected in series with parallel battery clusters. The total number of the voltage sources is n. A positive electrode of a first voltage source U₁, a positive electrode of a second voltage source U₂, . . . , and a positive electrode of an n-th voltage source Uₙ are respectively connected to a negative electrode of a first battery cluster B₁, a negative electrode of a second battery cluster B₂, . . . , and a negative electrode of an n-th battery cluster Bₙ. Negative electrodes of the first voltage source U₁ to the n-th voltage source Uₙ are connected together to form a negative electrode of the parallel battery clusters. An output current of the corresponding battery cluster can be controlled by controlling the polarity and amplitude of the voltage source, thereby controlling the energy flow among different parallel battery clusters.

The circulating current suppression and state-of-charge equalization circuit is specifically a converter topology with an output capacitor, including series capacitors, bi-directional converters, an intermediate bus capacitor, and a bi-directional DC/DC converter.

The positive electrodes of the battery clusters are connected to one another as a positive electrode of the parallel battery cluster. The negative electrode of each battery cluster is connected in series with a series capacitor respectively. The negative electrodes of the series capacitors are connected to one another as the negative electrode of the parallel battery cluster. The series capacitors are connected to a common output bus capacitor of the parallel battery clusters via a bi-directional converter cascaded to a bi-directional DC/DC converter for bi-directional energy transfer. For non-equalization in the current or state of charge among the battery clusters, by controlling the switching of switch transistors in each bi-directional converter and the switching of switch transistors in the bi-directional DC/DC converter, the power of part of the parallel battery clusters can be transferred to the remaining parallel battery clusters through the intermediate bus, thereby realizing the circulating current suppression among the battery clusters and the controlling of the state-of-charge equalization among the battery clusters.

Referring to FIG. 1, the total number of the battery clusters is n (n is a positive integer). Positive electrodes of the battery clusters B₁, B₂, . . . , and Bₙ are connected to one another as a positive electrode of the parallel battery cluster. The negative electrodes of the battery clusters B₁, B₂, . . . , and Bₙ, are connected to the positive terminals of series capacitors C₁, C₂, . . . , and Cₙ, respectively. The negative terminals of series capacitors C₁, C₂, . . . , and Cₙ are connected to one another as the negative electrode of the parallel battery cluster. The bi-directional converter includes a first bi-directional converter, a second bi-directional converter, . . . , an n-th bi-directional converter. The series capacitors C₁, C₂, . . . , and Cₙ are connected to the intermediate bus capacitor C₀ via the first bi-directional converter, the second bi-directional converter, . . . , and the n-th bi-directional converter, respectively. The bi-directional DC/DC converter includes a first bi-directional DC converter, a second bi-directional DC converter, . . . , and an n-th bi-directional DC converter. The common output capacitors for the parallel battery clusters are connected to the intermediate bus capacitors C₀ via the first bi-directional DC converter, the second bi-directional DC converter, . . . , and the n-th bi-directional DC converter, respectively.

In this embodiment, the parallel battery cluster topology integrated with a circulating current suppression and state-of-charge equalization circuit further includes a control circuit. The control circuit includes a battery cluster state of charge monitoring circuit and a bi-directional converter control circuit. The battery cluster state of charge monitoring circuit is configured to detect the state of charge of all battery clusters. The gates of the switch transistors of the bi-directional converter and the bi-directional DC/DC converter are configured to control the turn-on and turn-off of all switch transistors.

Referring to FIG. 1, the bi-directional converter is specifically a compound chopper circuit with a load short-circuit switch. The intermediate bus capacitor C₀ is connected to a high-voltage end of the compound chopper circuit, and the series capacitor is connected to a low-voltage end of the compound chopper circuit. The positive terminals of the first series capacitor C₁, the second series capacitor C₂, . . . , and the n-th series capacitor Cₙ are connected to the drains of the load short-circuit switches M₁, M₂, . . . , and Mₙ respectively. The negative terminals of the first series capacitor C₁, the second series capacitor C₂, . . . , and the n-th series capacitor Cₙ are connected to the sources of the load short-circuit switches M₁, M₂, . . . , and Mₙ respectively, and are jointly connected to the negative electrode of the parallel battery clusters.

Referring to FIG. 1, the bi-directional DC/DC converter is specifically a bi-directional DC converter with an output voltage stabilization function.

The intermediate bus capacitor C₀ is connected to the output terminal of the bi-directional DC/DC converter, and the common output capacitor for the parallel battery cluster is connected to the input terminal of the bi-directional DC/DC converter. The bi-directional DC converter is configured to maintain the stability of the bus capacitor voltage.

In this embodiment, by controlling the turn-on and turn-off of any number of load short-circuit switch transistors, the battery clusters that need circulating current suppression or state-of-charge equalization are selected for energy flow, and the battery clusters that don't need circulating current suppression or state-of-charge equalization can be blocked. The embodiment of the present disclosure maintains a stable voltage of the common DC bus capacitor while performing the circulating current suppression and state-of-charge equalization. In this embodiment, during operation, by controlling the switching of switch transistors in each bi-directional converter, the power of part of the parallel battery clusters can be transferred to the remaining parallel battery clusters through an intermediate bus, so as to control the circulating current suppression and the state-of-charge equalization among the battery clusters.

In the embodiment, by controlling switching of switch transistors in each bi-directional converter during operation, power of part of the parallel battery clusters may be transferred to the remaining parallel battery clusters through an intermediate bus, thereby realizing the circulating current suppression among the battery clusters and the controlling of the state-of-charge equalization among the battery clusters. The following equation is satisfied during the operation of system:

$${\sum }_{i = 1}^{n} {U}_{c i} \cdot {I}_{i} = 0$$

The total power consumption of series capacitors in the process of circulating current suppression and state-of-charge equalization is 0. Meanwhile, a voltage fluctuation amplitude of the intermediate bus capacitor is 0 by voltage stabilization of the DC/DC converter, so the system loss is low and the efficiency is high.

The present disclosure has the following advantages and beneficial effects compared with the prior art:

1. The present disclosure dynamically equalizes the battery clusters using series capacitors, bi-directional converters, and intermediate buses, to reduce the number of switch transistors and lower the cost. The circuit of the present disclosure is simple and efficient.

2. The present disclosure controls the switching of switch transistors in each bi-directional converter at the same time to transfer the power of part of parallel battery clusters to the remaining parallel battery clusters through the bi-directional converter and the intermediate bus, so as to control the circulating current suppression and the state-of-charge equalization among the battery clusters.

3. The present disclosure can control the stabilization of the voltage of the intermediate bus capacitor by controlling the switching of the switch transistors of each bi-directional DC/DC converter, so as to better control the circulating current suppression and the state-of-charge equalization.

4. The present disclosure controls the turn-on and turn-off of any number of load short-circuit switch transistors. The battery clusters that need current equalization or state-of-charge equalization are selected for energy flow, and the battery clusters that don't need current equalization or state-of-charge equalization can be blocked. The present disclosure maintains a stable voltage of the common DC bus capacitor and energy stability while suppressing circulating currents or realizing state-of-charge equalization among different parallel battery clusters.

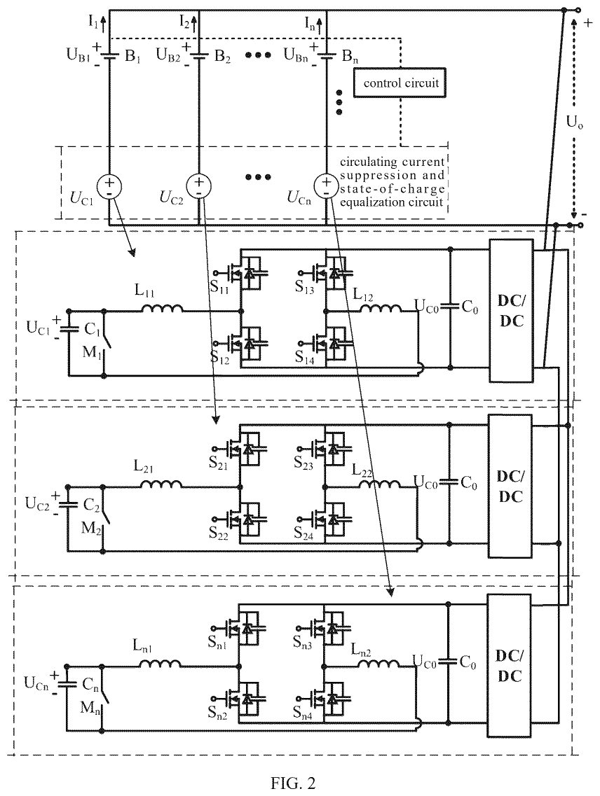

Referring to FIG. 2, in this embodiment, the bi-directional converter is configured as a compound chopper circuit with a load short-circuit switch. The compound chopper circuit includes two inductors and five switch transistors.

The present disclosure dynamically equalizes the battery clusters using series capacitors, bi-directional converters, and intermediate buses, to reduce the number of switch transistors and lower the cost. The circuit of the present disclosure is simple and efficient. By controlling the switching of switch transistors in each bi-directional converter, the power of part of the parallel battery clusters can be transferred to the remaining parallel battery clusters through an intermediate bus, so as to realize the controlling of current equalization of the battery clusters and the controlling of state-of-charge equalization among the battery clusters. By controlling the turn-on and turn-off of any number of load short-circuit switch transistors, the battery clusters that need circulating current suppression or state-of-charge equalization are selected for energy flow, and the battery clusters that don't need circulating current suppression or state-of-charge equalization can be blocked.

The following brief analysis gives the specific working mode of the parallel battery cluster topology integrated with a circulating current suppression and state-of-charge equalization circuit.

Assuming that only the first battery cluster and the second battery cluster need circulating current suppression or state-of-charge equalization during the operation of system, and the other battery clusters do not need it, then in this case, all of the load short-circuit switches of the bidirectional converters of the other battery clusters are turned on, and only the load short-circuit switches of the first battery cluster and the second battery cluster are turned off. At this time, the discharge current of the first battery cluster is denoted as I₁, and the discharge current of the second battery cluster is denoted as I₂. The current reference values that the two battery clusters need to be achieve after equalization are I_{ref1} and I_{ref2}, respectively. If I₁<I₂, then the discharge current of the first battery cluster needs to be increased, and the discharge current of the second battery cluster needs to be reduced. The series amplitude of the voltage source of the first battery cluster should be positive, and the series amplitude of the voltage sources of the second battery cluster should be negative.

There is an equation in the current equalization process of first battery cluster:

$$\frac{{U}_{Boc} + {U}_{C 1} - {U}_{o}}{{R}_{e q}} = {I}_{ref 1} \qquad ( 1 )$$

The following equation is thus obtained:

$${U}_{C 1} = {I}_{ref 1} \cdot {R}_{e q} - {U}_{Boc} + {U}_{o} > 0 \qquad ( 2 )$$

Then the output power of the corresponding bidirectional converter is derived from the voltage value of the series voltage source and the output current reference value of the corresponding battery cluster:

$${P}_{1} = {U}_{C 1} \cdot {I}_{ref 1} = {I}_{ref 1}^{2} \cdot {R}_{e q} - {U}_{Boc} \cdot {I}_{ref 1} + {U}_{o} \cdot {I}_{ref 1} > 0 \qquad ( 3 )$$

The following equation is established for the current equalization process of the second battery cluster:

$$\frac{{U}_{Boc} + {U}_{C 2} - {U}_{o}}{{R}_{e q}} = {I}_{ref 2} \qquad ( 4 )$$

The following equation is thus obtained:

$${U}_{C 2} = {I}_{ref 2} \cdot {R}_{e q} - {U}_{B o c} + {U}_{o} < 0 \qquad ( 5 )$$

Then the output power of the corresponding bidirectional converter is derived from the voltage value of the series voltage source and the output current reference value of the corresponding battery cluster:

$${P}_{2} = {U}_{C 2} \cdot {I}_{ref 2} = {I}_{ref 2}^{2} \cdot {R}_{e q} - {U}_{Boc} \cdot {I}_{ref 2} + {U}_{o} \cdot {I}_{ref 2} < 0 \qquad ( 6 )$$

If the intermediate bus capacitor voltage is controlled to remain constant during this process, the power released by the first converter at this time is equal to the power absorbed by the second converter, that is:

$${P}_{1} + {P}_{2} = 0 \qquad ( 7 )$$

Therefore, at this time, the output power of different converters satisfies the following equation:

$${\sum }_{i = 1}^{m} {P}_{i} = 0 \qquad ( 8 )$$

The following equation is thus obtained:

$${\sum }_{i = 1}^{m} {U}_{c i} \cdot {I}_{i} = 0 \qquad ( 9 )$$

From this analysis, it can be found that the parallel battery cluster topology integrated with a circulating current suppression and state-of-charge equalization circuit has a series capacitance and power consumption of 0 during the process of the circulating current suppression or state-of-charge equalization, so the system has low loss and high efficiency.

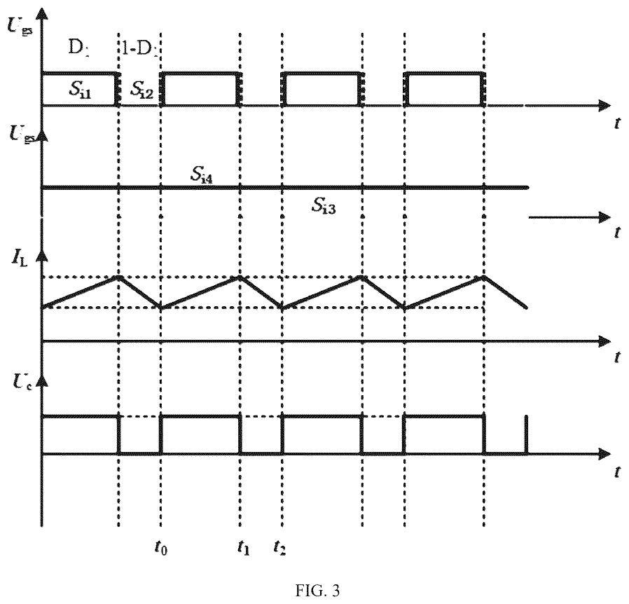

The main working principle of the bidirectional converter is analyzed below. The waveforms of the driving signal, the inductor current, and the capacitor voltage of the bidirectional converter of the first battery cluster are shown in FIG. 3 respectively. At this time, the third switch S₁₃ is continuously off during this process. The fourth switch S₁₄ is continuously on during this process. The first switch S₁₁ and the second switch S₁₂ are alternately turned on according to modulation results, and the duty cycle D₁ is determined according to the magnitude of ΔI.

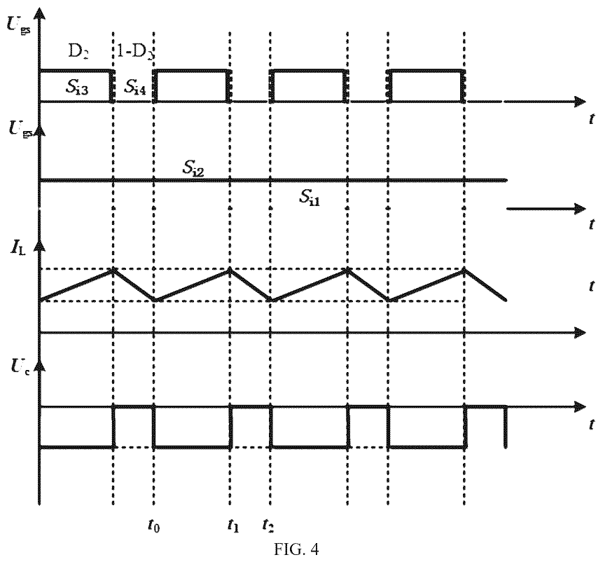

The waveforms of the driving signal, the inductor current, and the capacitor voltage of the bidirectional converter of the second battery cluster are shown in FIG. 4 respectively. At this time, the first switch S₂₁ is continuously off during this process, and the second switch S₂₂ continues to be on during this process. The third switch S₂₃ and the fourth switch S₂₄ are alternately turned on according to the modulation results. The duty cycle D₂ is determined according to the magnitude of ΔI.

Assuming that D₁=D₂ in this process, there are two working stages in total:

Stage 1 (t₀~t₁):

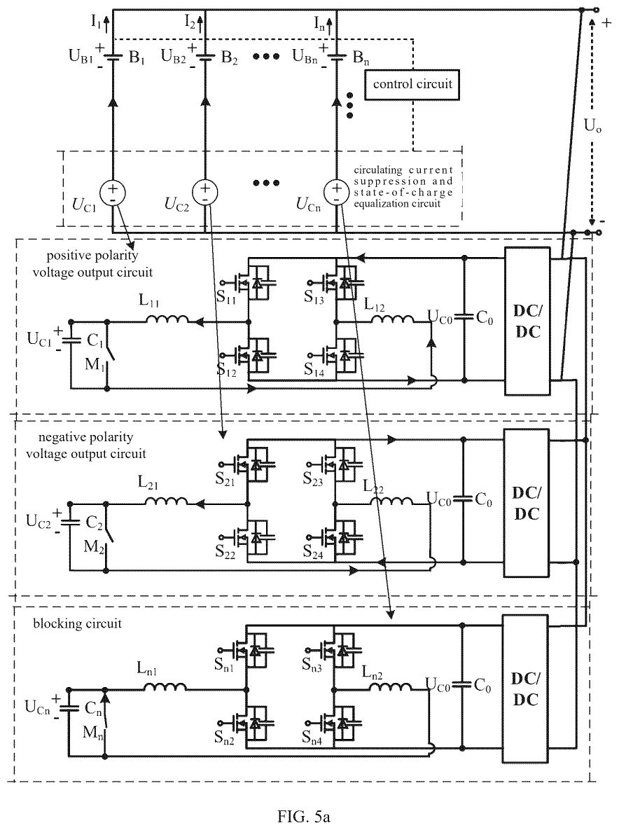

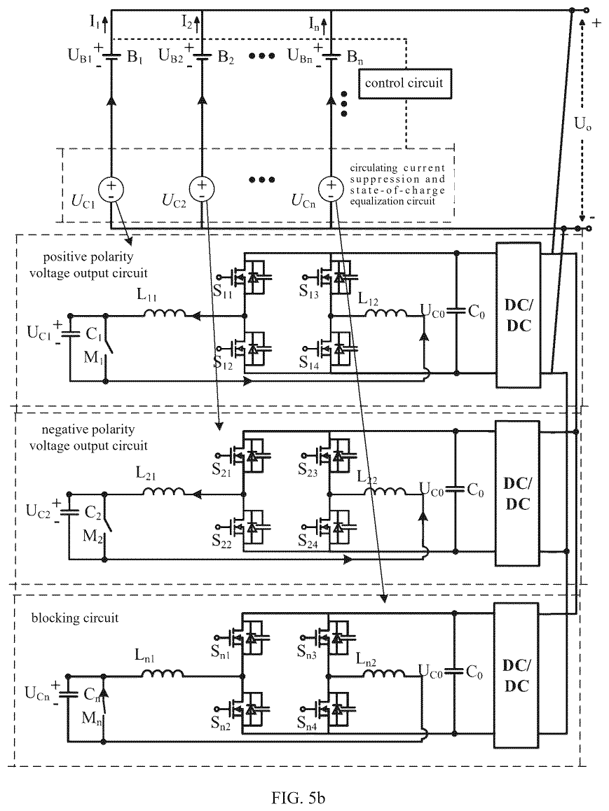

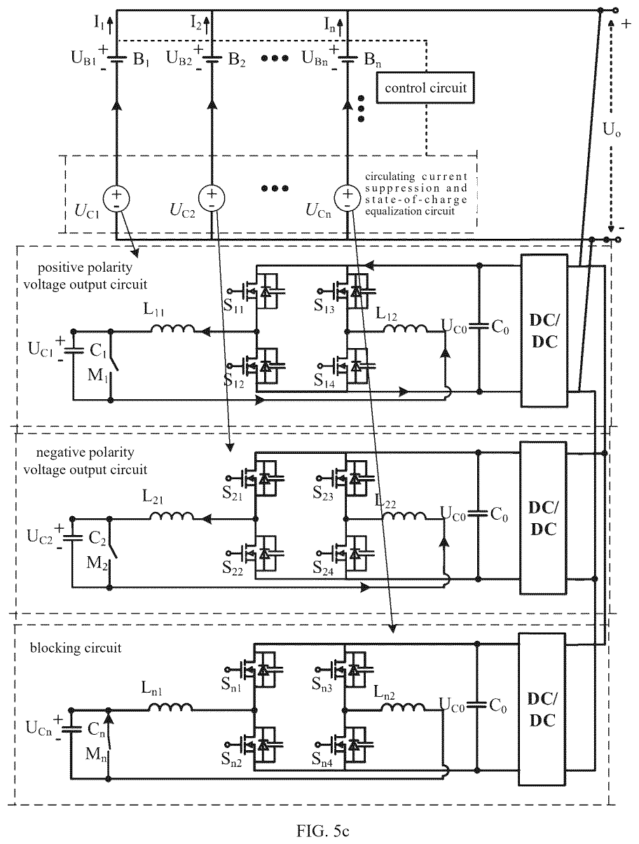

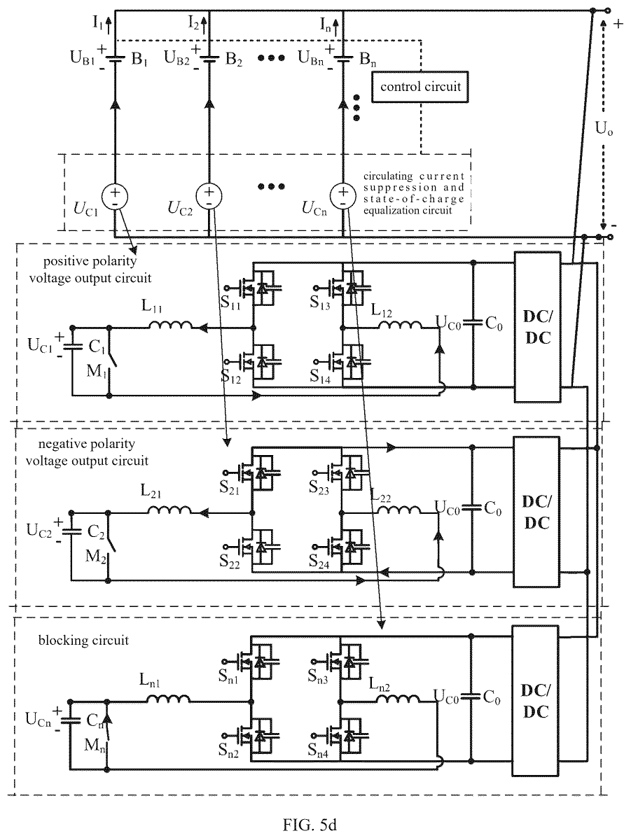

As shown in FIG. 5a, the main switches S₁₁, S₁₄, S₂₂, and S₂₃ are in the on state, and the currents of the output inductors L₁₁, L₁₂, L₂₁, and L₂₂ increase linearly.

Stage 2 (t₁~t₂):

As shown in FIG. 5b, the main switches S₁₂, S₁₃, S₂₁, and S₂₄ are in the on state, and the currents of the output inductors L₁₁, L₁₂, L₂₁, and L₂₂ decrease linearly.

If D₁>D₂ in this process, then a period of time (D₁−D₂)·Tₛ will be added between stage 1 and stage 2 in which S₁₁, S₁₄, S₂₂, and S₂₄ are in the on state, as shown in FIG. 5c.

If D₁<D₂ in this process, a period of time (D₂−D₁)·Tₛ will be added between stage 1 and stage 2 in which S₁₂, S₁₄, S₂₂, and S₂₃ are in the on state, as shown in FIG. 5d.

It should also be noted that in this specification, terms such as “include”, “contain” or any other variation thereof are intended to cover non-exclusive inclusion, such that a process, method, article, or device that includes a series of elements not only includes those elements, but also other elements not expressly listed or inherent in such process, method, article, or device. Without further limitation, an element defined by the statement “includes a . . . ” does not exclude the presence of additional identical elements in a process, method, article, or device that includes the stated element.

The above description of the disclosed embodiments enables those skilled in the art to implement or use the present disclosure. Various modifications to these embodiments will be readily apparent to those skilled in the art, and the general principles defined herein may be implemented in other embodiments without departing from the spirit or scope of the present disclosure. Therefore, the present disclosure is not to be limited to the embodiments shown herein but is to be accorded the widest scope consistent with the principles and novel features disclosed herein.

1. A parallel battery cluster topology integrated with a circulating current suppression and state-of-charge equalization circuit, wherein the circulating current suppression and state-of-charge equalization circuit includes a plurality of parallel battery clusters and a plurality of voltage sources connected in series with the parallel battery clusters respectively, the parallel battery cluster topology comprising:
positive electrodes of the plurality of voltage sources U₁ to Uₙ are respectively connected to negative electrodes of the plurality of battery clusters B₁ to Bₙ, and
negative electrodes of the plurality of voltage sources U₁ to Uₙ are connected together to form a negative electrode of the parallel battery clusters,
wherein by controlling the polarity and amplitude of the voltage source during operation, an output current of the corresponding battery cluster is controlled, thereby controlling the energy flow among different parallel battery clusters.

2. The parallel battery cluster topology according to claim 1, wherein the circulating current suppression and state-of-charge equalization circuit being a converter topology with an output capacitor, the parallel battery cluster topology comprises series capacitors, bi-directional converters, an intermediate bus capacitor, and a bi-directional DC/DC converter, positive electrodes of the battery clusters being connected to one another as a positive electrode of the parallel battery cluster,
wherein the series capacitors being connected in series with negative electrodes of the battery clusters respectively, negative electrodes of the series capacitors being connected to one another as the negative electrode of the parallel battery cluster, and
wherein the series capacitors being connected to the intermediate bus capacitor via a bi-directional converter for bi-directional energy transfer.

3. The parallel battery cluster topology according to claim 2, wherein each of the positive electrodes of the battery clusters is connected to one another and the positive electrode of the parallel battery cluster includes:
the positive electrode of the first battery cluster B₁, the positive electrode of the second battery cluster B₂, . . . , and the positive electrode of the n-th battery cluster Bₙ being connected to one another as the positive electrode of the parallel battery cluster; and
the series capacitors comprising a first series capacitor C₁, a second series capacitor C₂, . . . , and an n-th series capacitor Cₙ, a positive terminal of the first series capacitor C₁, a positive terminal of the second series capacitor C₂, . . . , and a positive terminal of the n-th series capacitor Cₙ being connected to the negative electrode of the first battery cluster B₁, the negative electrode of the second battery cluster B₂, . . . , and the negative electrode of the n-th battery cluster Bₙ, respectively, and the negative terminal of the first series capacitor C₁, the negative terminal of the second series capacitor C₂, . . . , and the negative terminal of the n-th series capacitor Cₙ being connected to one another as the negative electrode of the parallel battery cluster.

4. The parallel battery cluster topology according to claim 2, wherein the series capacitors are connected to the intermediate bus capacitor via the bi-directional converter and includes:
the first series capacitor C₁, the second series capacitor C₂, . . . , and the n-th series capacitor Cₙ, being connected to the intermediate bus capacitor C₀ via a first bi-directional converter, a second bi-directional converter, . . . , and an n-th bi-directional converter, respectively.

5. The parallel battery cluster topology according to claim 1, wherein the voltage source includes a bi-directional converter and a DC/DC converter with an output series capacitor and a load short-circuit switch, and the bi-directional converter is cascaded to a DC/DC converter which is connected to an output capacitor for the parallel battery cluster.

6. The parallel battery cluster topology according to claim 2, further comprising a control circuit, wherein the control circuit includes a battery cluster state of charge monitoring circuit and a bi-directional converter control circuit,
the battery cluster state of charge monitoring circuit is configured to detect the state of charge of all battery clusters; and
the gates of switch transistors of the bi-directional converter and the bi-directional DC/DC converter are configured to control the turn-on and turn-off of all switch transistors.

7. The parallel battery cluster topology according to claim 2, wherein the bi-directional converter is a compound chopper circuit with a load short-circuit switch;
the intermediate bus capacitor C₀ is connected to a high-voltage end of the compound chopper circuit, and the series capacitor is connected to a low-voltage end of the compound chopper circuit; and
the positive terminals of series capacitor C₁ to Cₙ are connected to the drains of the load short-circuit switches M₁ Mₙ respectively, and the negative terminals of series capacitors C₁ to Cₙ are connected to the sources of the load short-circuit switches M₁ to Mₙ respectively, and are jointly connected to the negative electrode of the parallel battery clusters.

8. The parallel battery cluster topology according to claim 2, wherein the bi-directional DC/DC converter is a bi-directional DC converter with output voltage stabilization function, and is configured to maintain stability of the bus capacitor voltage, and
the intermediate bus capacitor C₀ is connected to the output terminal of the bi-directional DC converter, and the output capacitor for the parallel battery cluster is connected to an input terminal of the bi-directional DC/DC converter.

9. The parallel battery cluster topology according to claim 2, wherein by controlling switching of switch transistors in each bi-directional converter during operation, power of part of the parallel battery clusters is transferred to the remaining parallel battery clusters through a common output bus of the parallel battery clusters, thereby realizing the circulating current suppression among the battery clusters and the controlling of the state-of-charge equalization among the battery clusters.

10. The parallel battery cluster topology according to claim 9, wherein the following equation is satisfied during operation:
$${\sum }_{i = 1}^{n} {U}_{c i} \cdot {I}_{i} = 0 ,$$
and wherein a total power consumption of the series capacitors in the process of the circulating current suppression and state-of-charge equalization is 0, and a voltage fluctuation amplitude of the intermediate bus capacitor is 0 by voltage stabilization of the DC/DC converter.
